(19) United States
(12) Patent Application Publication
(10) Pub. No.: US 2026/0349376 A1
(43) Pub. Date: Nov. 5, 2026

(54) FIXING DEVICE AND IMAGE FORMING APPARATUS

(71) Applicant: CANON KABUSHIKI KAISHA, Tokyo (JP)

(72) Inventors: TAKUYA HASEGAWA, Tokyo (JP); RIKIYA TAKEMASA, Chiba (JP); TAKESHI KOZUMA, Ibaraki (JP); MASAKI FURUTANI, Chiba (JP); TOMOHIRO HASEGAWA, Chiba (JP)

(21) Appl. No.: 19/661,463

(22) Filed: Apr. 28, 2026

(30) Foreign Application Priority Data
May 1, 2025 (JP) 2025-076475

(51) Int. Cl. G03G 15/00; G03G 15/20

(52) U.S. Cl. CPC G03G 15/50; G03G 15/2064; G03G 15/70; G03G 2215/00603; G03G 2215/00734; G03G 2215/2038

(57) ABSTRACT

A fixing device includes a heating rotational member, a pressing rotational member, a fixing nip portion, a fixing motor, and a control unit configured to control a fixing speed, wherein the control unit controls the fixing motor, in a case where a sheet size setting of the recording medium with a size in a conveyance direction larger than a predetermined size is made, to operate at the fixing speed of a first speed, in a case where the sheet size setting of the recording medium with a size in the conveyance direction smaller than the predetermined size is made, to operate at the fixing speed of a second speed lower than the first speed in a case of a free size mode, to operate at the fixing speed of the first speed when the first sheet of the recording medium reaches the fixing device.

### BACKGROUND

### Field of the Technology

The present disclosure relates to a fixing device and an image forming apparatus.

### Description of the Related Art

An electrophotographic image forming apparatus transfers a toner image of each color formed by an image forming unit onto an intermediate transfer belt, and performs secondary transfer of the toner image onto a recording medium at a secondary transfer portion configured of a pair of secondary transfer rollers. In addition, a technique of fixing the toner image onto the recording medium in the fixing device by conveying the secondarily-transferred toner image while pressing and heating at a fixing nip portion formed of a heating member and a pressure member is widely used.

Conventionally, when a recording medium long in a conveyance direction such as a long size sheet is supplied, due to a difference in the conveyance speed of the recording medium between the fixing nip portion and the secondary transfer portion, image distortion has occurred at the time of secondary transfer because the conveyance speed of the recording medium at the fixing nip portion becomes higher than that at the secondary transfer portion. As a method for preventing the image distortion at the secondary transfer portion, a technique of providing a member that detects a slack (hereinbelow, referred to as a loop) of the recording medium between the secondary transfer portion and the fixing nip portion to maintain the loop constant is known.

Japanese Patent Laid-open No. 2021-196402 describes a method of controlling the loop to be constant by performing acceleration/deceleration control (hereinbelow, referred to as a loop control) at the fixing nip portion.

In the loop control, since the conveyance speed at the fixing nip portion is controlled to be faster or slower than a reference sheet conveyance speed (hereinbelow, referred to as a process speed), the load on a fixing drive member is larger than when the fixing drive member is driven constantly at the process speed. Further, since the loop control worsens the abrasion on the surfaces of the heating member and the pressure member, the service life of the fixing device becomes shorter.

For this reason, a threshold (referred to as an Lloop) for a recording medium size (predetermined size) at which the image distortion does not occur at the time of secondary transfer due to the difference in the conveyance speed of the recording medium between the fixing nip portion and the secondary transfer portion is set. In a case where the recording medium size in the conveyance direction is smaller than the threshold size (i.e., the size in the conveyance direction < Lloop), the conveyance speed at the fixing nip portion is controlled to be fixed to the process speed. In a case where the recording medium size in the conveyance direction is the threshold size or larger (i.e., the size in the conveyance direction ≥ Lloop), the loop control is performed.

### SUMMARY

According to some embodiments of the present disclosure, a fixing device for fixing an unfixed toner image formed on a recording medium onto the recording medium includes a heating rotational member configured to heat the recording medium, a pressing rotational member configured to form, together with the heating rotational member, a fixing nip portion for nipping and conveying the recording medium, a fixing motor configured to provide a rotational driving force to the pressing rotational member, and a control unit configured to control a fixing speed by controlling the fixing motor, wherein the control unit controls the fixing motor, in a case where a sheet size setting of the recording medium with a size in a conveyance direction larger than a predetermined size is made, to operate at the fixing speed of a first speed when a first sheet of the recording medium reaches the fixing device, wherein the control unit controls the fixing motor, in a case where the sheet size setting of the recording medium with a size in the conveyance direction smaller than the predetermined size is made, to operate at the fixing speed of a second speed lower than the first speed when the first sheet of the recording medium reaches the fixing device, and wherein the control unit controls the fixing motor, in a case of a free size mode in which the sheet size setting is not made, to operate at the fixing speed of the first speed when the first sheet of the recording medium reaches the fixing device.

Features of the present disclosure will become apparent from the following description of embodiments with reference to the attached drawings. The following description of embodiments is described by way of example.

### BRIEF DESCRIPTION OF THE DRAWINGS

FIG. 1 is a schematical view illustrating an image forming apparatus.

FIG. 2 is a cross-sectional view schematically illustrating a portion around a fixing device according to first and second embodiments.

FIG. 3 is a cross-sectional view schematically illustrating a loop control operation according to the first and second embodiments.

FIG. 4 is a cross-sectional view schematically illustrating the loop control operation according to the first and second embodiments.

FIG. 5 is a cross-sectional view schematically illustrating the loop control operation according to the first and second embodiments.

FIGS. 6A and 6B are sequence diagrams illustrating normal operations of a fixing motor according to the first and second embodiments.

FIGS. 7A and 7B are diagrams illustrating operations of the fixing motor in a free size mode according to the first embodiment.

FIGS. 8A and 8B are respectively a block diagram of the image forming apparatus and a flowchart illustrating an operation flow of the image forming apparatus according to the first embodiment.

FIGS. 9A and 9B are diagrams illustrating operations of a fixing motor in a free size mode according to the second embodiment.

### DESCRIPTION OF THE EMBODIMENTS

Hereinbelow, various exemplary embodiments, features, and aspects of the present disclosure will be described with reference to the drawings. The embodiments are examples of the best mode in the present disclosure, but the present disclosure is not limited to these embodiments.

### First Embodiment

### Image Forming Apparatus

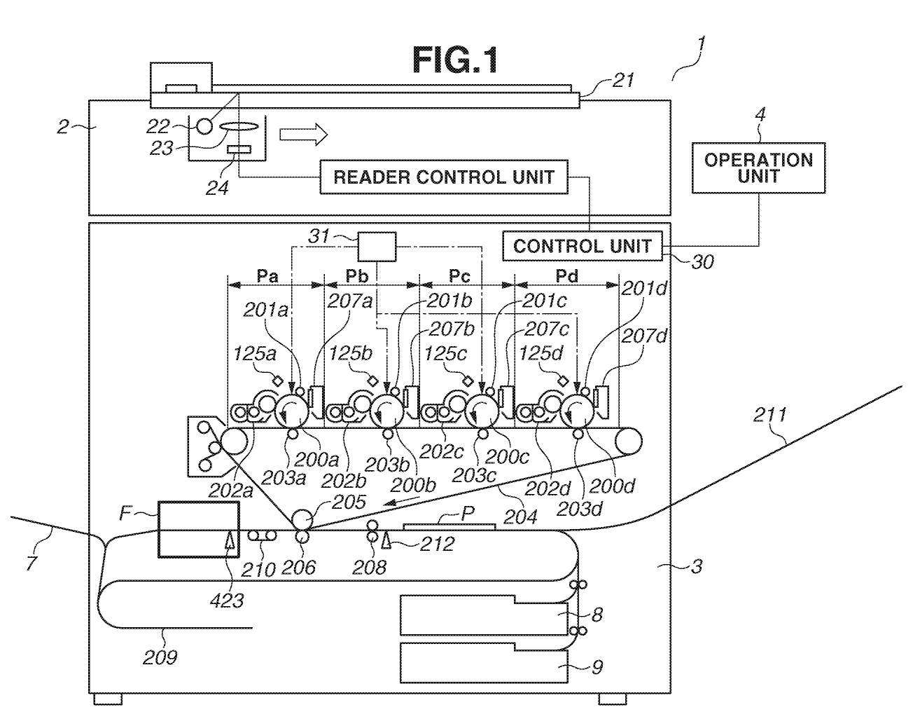

A schematic configuration of an image forming apparatus 1 according to a first embodiment will be described with reference to FIG. 1. FIG. 1 is a cross-sectional view illustrating a full-color image forming apparatus according to the present embodiment. The image forming apparatus 1 includes an image reading unit 2 and an image forming apparatus main body 3. The image reading unit 2 is a unit for reading a document placed on a platen glass 21. Light emitted from a light source 22 is reflected from the document, and the reflected light is focused on a charge-coupled device (CCD) sensor 24 via an optical system member 23 such as a lens. Such an optical system unit scans the document in an arrow direction to convert the scanned document into an electrical signal data array for each line. An image signal acquired by the CCD sensor 24 is transmitted to the image forming apparatus main body 3, and a control unit 30 performs image processing corresponding to each image forming unit described below. Further, the control unit 30 receives an external input as an image signal from an external host apparatus such as a print server.

The image forming apparatus main body 3 is configured to convey a recording medium P in a horizontal direction (right to left in FIG. 1) as a whole. The image forming apparatus main body 3 includes a plurality of image forming units Pa, Pb, Pc, and Pd, each configured to form an image based on the above-described image signal. More specifically, the image signal is converted into a laser beam pulse-width modulated (PWM) by the control unit 30. In FIG. 1, a polygon scanner 31 serving as an exposure device scans a laser beam corresponding to the image signal. Then, a laser beam is emitted to each of photosensitive drums 200a to 200d serving as image bearing members of the image forming units Pa to Pd.

In addition, the image forming unit Pa is an image forming unit for yellow (Y), the image forming unit Pb is an image forming unit for magenta (M), the image forming unit Pc is an image forming unit for cyan (C), and the image forming unit Pd is an image forming unit for black (Bk). Each of the image forming units Pa, Pb, Pc, and Pd forms an image of a corresponding color. Since the image forming units Pa to Pd have substantially the same configurations, the Y image forming unit Pa is described in detail below, and descriptions of other image forming units Pb, Pc, and Pd are omitted. The Y image forming unit Pa includes a photosensitive drum 200a, and a toner image is formed on the surface of the photosensitive drum 200a based on the image signal as described below.

The Y image forming unit Pa includes a primary charging unit 201a for charging the surface of the photosensitive drum 200a to a predetermined voltage to prepare for forming an electrostatic latent image. An electrostatic latent image is formed by a laser beam from the polygon scanner 31 on the surface of the photosensitive drum 200a charged to the predetermined voltage. A developing device 202a develops the electrostatic latent image on the photosensitive drum 200a to form a toner image. A transfer roller 203a applies a primary transfer bias with a polarity opposite to the toner by discharging from the backside of an intermediate transfer belt 204 to transfer the toner image on the photosensitive drum 200a onto the intermediate transfer belt 204. Then, the surface of the photosensitive drum 200a after the toner image is transferred therefrom is cleaned by a cleaner 207a.

Further, the toner image on the intermediate transfer belt 204 is conveyed to the next image forming units so that toner images of other colors formed on other image forming units are transferred onto the intermediate transfer belt 204 in order of Y, M, C, and Bk, and a four-color image is formed on the surface of the intermediate transfer belt 204. The toner image that has passed through the Bk image forming unit Pd is secondarily transferred onto the recording medium P, by applying a secondary transfer electric field with a polarity opposite to the toner image on the intermediate transfer belt 204 at the secondary transfer portion configured of a pair of secondary transfer rollers 205 and 206. After the recording medium P fed from a sheet feed cassette 8, 9, or a multi-tray 211 stands by at a registration portion 208, a timing for conveying the recording medium P from the registration portion 208 is controlled so as to match the positions of the toner image on the intermediate transfer belt 204 and the recording medium P, and then the recording medium P is conveyed from the registration portion 208. Then, after passing through the pair of secondary transfer rollers 205 and 206, the recording medium P is conveyed to a fixing device F by a pre-fixing conveyance belt 210, and the toner image on the recording medium P is fixed onto the recording medium P. In the case of a one-sided job, after passing through the fixing device F, the recording medium P is discharged outside the image forming apparatus main body 3. In the case of a two-sided job, after completing the toner transfer and the toner fixing on an image forming first surface (first surface), the recording medium P is reversed by passing through a reversing portion 209 provided inside the image forming apparatus 1, a toner image is transferred and fixed onto an image forming second surface (second surface), and the recording medium P with the toner image fixed thereon is discharged outside the image forming apparatus main body 3 to be stacked on a sheet discharge tray 7.

### Fixing Device

Next, a configuration of the fixing device F according to the embodiment of the present disclosure will be described.

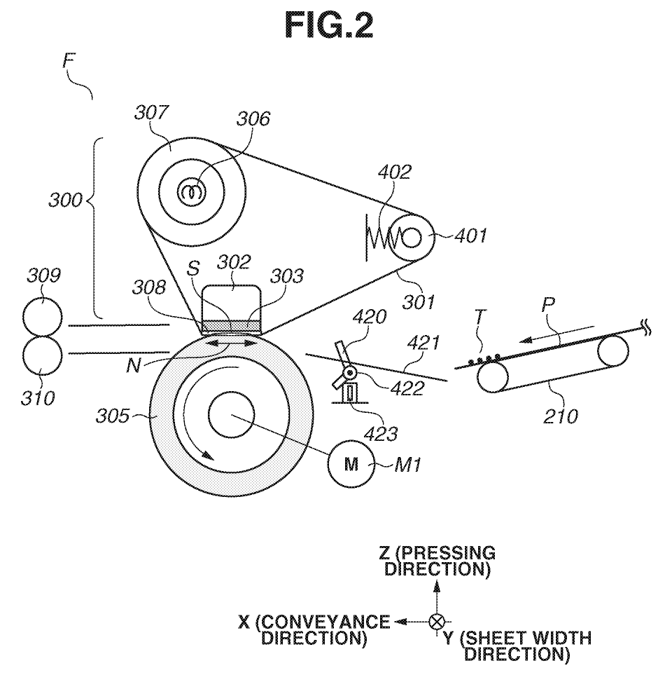

FIG. 2 is a schematic diagram of an overall configuration of the fixing device F of a belt heating type according to the embodiment of the present disclosure. In FIG. 2, an X direction indicates a conveyance direction of the recording medium P, a Y direction indicates a sheet width direction, and a Z direction indicates a pressing direction.

The fixing device F is a fixing device for fixing an unfixed toner image T formed on the recording medium P onto the recording medium P, and includes the following components. The fixing device F includes a heating unit 300 including a fixing belt (hereinbelow, referred to as a belt) 301, which is an endless, rotatable heating rotational member, a pressure pad (hereinbelow, referred to as a pad) 303 for supporting a fixing member, a stay 302 for supporting the pad 303, a heating roller 307, and a steering roller 401, and a pressure roller 305 serving as a pressing rotational member facing the belt 301 to form a fixing nip portion N with the belt 301.

The belt 301 has thermal conductivity, heat resistance, and other properties, and has a thin-walled cylindrical shape. In the present embodiment, the belt 301 has a three-layered structure in which a base layer, an elastic layer around the base layer, and a mold release layer around the elastic layer, which are not illustrated, are formed. The base layer is 80 micrometers (μm) in thickness and is made of polyimide resin (PI), the elastic layer is 300 μm in thickness and is made of silicone rubber, and the mold release layer is 30 μm in thickness and is made of tetrafluoroethylene-perfluoroalkoxyethylene copolymer resin (PFA) as fluororesin. The belt 301 is stretched by the pad 303, the heating roller 307, and the steering roller 401.

The pad 303 is pressed by the pressure roller 305 across the belt 301. The pad 303 is made of liquid crystalline polymer (LCP). Between the pad 303 and the belt 301, a lubricating sheet 308 with its surface coated by polytetrafluoroethylene (PTFE), and silicone oil S (hereinbelow, referred to as oil S) serving as a lubricant are provided, so that the belt 301 smoothly slides against the pad 303.

The lubricating sheet 308 is formed by coating the PTFE on the surface of a 70 μm thick polyimide substrate. In addition, since the lubricating sheet 308 is arranged to improve the slidability between the pad 303 and the belt 301, the lubricating sheet 308 can be substituted by application of a coating or the like for improving the slidability on the surface layer of the pad 303.

The steering roller 401 is disposed inside the belt 301 to stretch the belt 301 together with the pad 303 and the heating roller 307, and is driven to rotate by the belt 301. Further, the steering roller 401 is urged against the belt 301 by a pressure spring 402 serving as an urging member, and also functions as a tension roller for applying a predetermined tensile force to the belt 301. The steering roller 401 is configured of a cylindrical member and an elastic layer provided around the cylindrical member, for example, the cylindrical member is a stainless steel pipe with an outer diameter of 20 mm and a thickness of 1 mm, and the elastic layer is formed of a silicone rubber layer with a thickness of 100 μm.

The heating roller 307 is a stainless steel pipe with a thickness of 1 mm, includes a halogen heater 306 inside the heating roller 307 serving as a heat source, and can be heated to a predetermined temperature. The belt 301 is heated by the heating roller 307.

The pressure roller 305 is a roller including a core metal layer, an elastic layer around the outer periphery of a shaft, and a release layer around the outer periphery of the elastic layer. A stainless steel (SUS) member with a diameter of 72 mm is used for the shaft, a conductive silicone rubber with a thickness of 8 mm is used for the elastic layer, and PFA, which is fluororesin, with a thickness of 100 μm is used for the mold release layer. The pressure roller 305 is pivotally supported by a fixing frame (not illustrated) of the fixing device F, a gear is fixed to its one end, and the pressure roller 305 is connected to a fixing motor M1 via the gear to be rotationally driven. In other words, the fixing motor M1 provides a rotational driving force to the pressure roller 305.

The recording medium P with a toner image borne thereon is nipped at the fixing nip portion N formed between the belt 301 and the pressure roller 305 to be heated while being conveyed. In this way, the fixing device F fixes the toner image onto the recording medium P while nipping and conveying the recording medium P. Thus, the fixing device F may have both functions of applying heat and pressure, and conveying the recording medium P. The pressure roller 305 is pressed against the pad 303 via the belt 301 by a driving source (not illustrated). The pressing force at the fixing nip portion N when printing is set to 1,600 N, the width of the fixing nip portion N in the X direction (conveyance direction) is set to 24.5 millimeters (mm), and the width of the fixing nip portion N in the Y direction (sheet width direction) is set to 326 mm.

A pair of discharge rollers 309 and 310 for discharging the recording medium P that has passed through the fixing nip portion N outside the fixing device F is disposed downstream of the fixing nip portion N in the conveyance direction.

### Loop Control

A loop control, which is a feature of the present disclosure, will be described.

As illustrated in FIG. 1, a pre-registration sensor 212 is disposed immediately before the registration portion 208. The pre-registration sensor 212 has a function of determining a paper jam of the recording medium P at the sheet feed cassettes 8 and 9, and a function of determining the size of the recording medium P in the conveyance direction based on a passing time of the recording medium P in a free size mode.

Further, as illustrated in FIG. 2, a loop detection flag 420 is rotatably supported by a pivotal shaft 422 at a position upstream of the fixing nip portion N in the conveyance direction of the recording medium and immediately before the fixing nip portion N, and is arranged to protrude in a sheet conveyance path 421. A loop detection sensor 423 for detecting the orientation of the loop detection flag 420 is arranged to estimate the state of the recording medium P between the pair of secondary transfer rollers 205 and 206, and the fixing nip portion N based on the signal detected by the loop detection sensor 423, and the rotational speed of the fixing motor M1 is changed based on the signal (ON/OFF) detected by the loop detection sensor 423.

The distance from the pre-registration sensor 212 to the pair of secondary transfer rollers 205 and 206 is 100 mm, the distance from the pair of secondary transfer rollers 205 and 206 to the fixing nip portion N is 220 mm, and the distance from the loop detection flag 420 to the fixing nip portion N is 35 mm. In the present embodiment, a threshold Lloop for the size (predetermined size) that may cause the image distortion when the secondary transfer is performed, due to the difference in the conveyance speed of the recording medium P between the fixing nip portion N and the secondary transfer portion used for performing the loop control is set to 500 mm.

The rotational speed of the fixing motor M1 for making the conveyance speed of the recording medium P at the fixing nip portion N equal to the process speed (350 mm/sec in the present embodiment) is referred to as "Middle", and the fixing speed at the rotational speed "Middle" is referred to as a second speed. The rotational speed of the fixing motor M1 for eliminating the loop of the recording medium P located across the pair of secondary transfer rollers 205 and 206 and the fixing nip portion N is referred to as "High", and the fixing speed at the rotational speed "High" is referred to as a first speed. The rotational speed of the fixing motor M1 for increasing the loop of the recording medium P located across the pair of secondary transfer rollers 205 and 206 and the fixing nip portion N is referred to as "Low", and the fixing speed at the rotational speed "Low" is referred to as a third speed. Estimated conveyance speeds of the recording medium P at the fixing nip portion N when the fixing motor M1 is rotated at respective speeds according to the present embodiment are as follows.
"High": 364 mm/sec (104 % of the process speed)
"Middle": 350 mm/sec (100 % of the process speed)
"Low": 336 mm/sec (96 % of the process speed)

Control method 1: In a case where the set sheet size L < Lloop is satisfied, since the loop control may not be used for this size, rotation is started at a fixing speed of "Middle", and the loop control based on the signal of the loop detection sensor 423 is not performed even after the conveyed sheet reaches the fixing nip portion N.

Control method 2: On the other hand, in a case where the set sheet size L ≥ Lloop is satisfied, since the loop control may be used for this size, rotation is started at a fixing speed of "High", and after the conveyed sheet reaches the fixing nip portion N, the loop control based on the signal of the loop detection sensor 423 is performed.

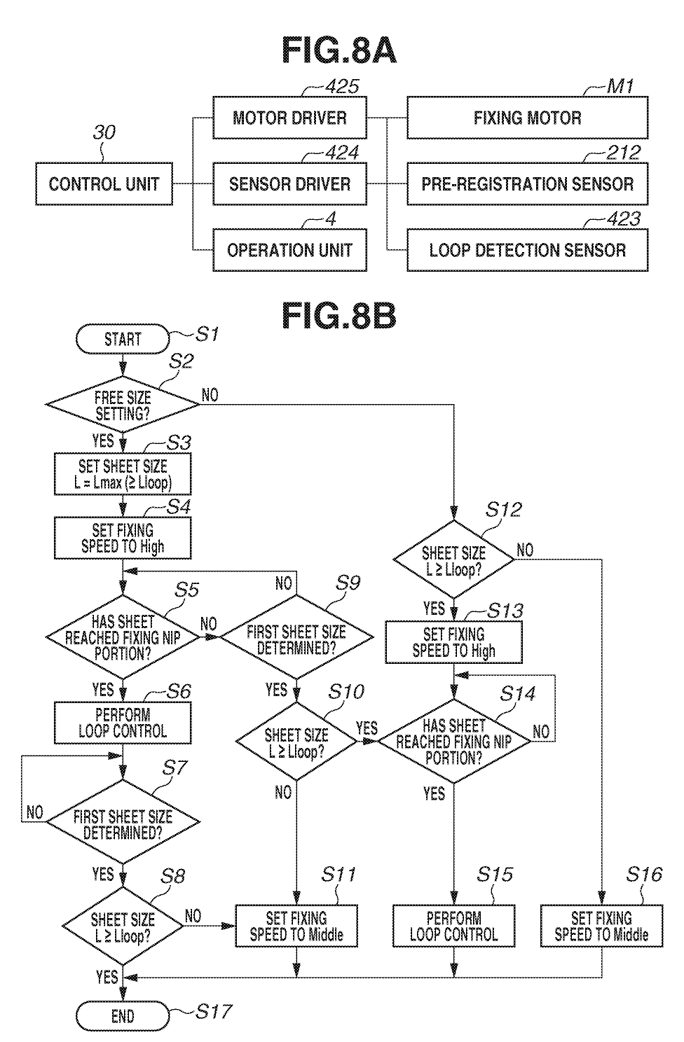

At this time, in the case of a free size setting that has no sheet size setting, since whether the sheet size is larger than or smaller than the Lloop is indefinite, the fixing speed is started at "High", and the sheet supply is started. When the supply of the sheet is started and the sheet size is determined, the above-described method 1 or method 2 is employed based on the sheet size. Hereinbelow, details of the loop control will be described with reference to FIGS. 8A and 8B.

The difference of the operation based on whether the free size setting is made (size setting of the recording medium is made) and the size of the supplied recording medium P in the conveyance direction will be described with reference to an operation flowchart in FIG. 8B according to the first embodiment. Further, as illustrated in a block diagram in FIG. 8A, the speed of the fixing motor M1 is changed by a motor driver 425 to change the conveyance speed of the recording medium P at the fixing nip portion N, based on the sheet size setting (size setting of recording medium, or free size mode setting) set from an operation unit 4 via the control unit 30, and the signals input to a sensor driver 424 from the pre-registration sensor 212 and the loop detection sensor 423.

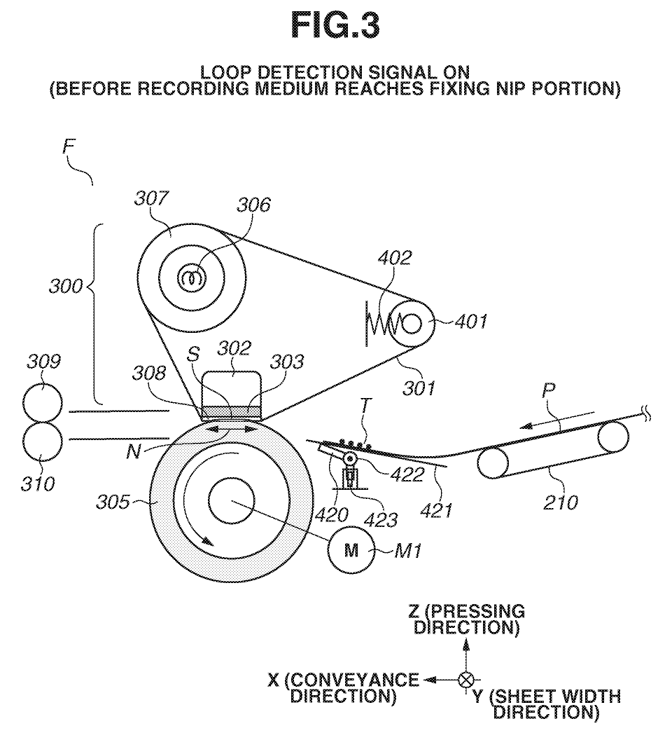

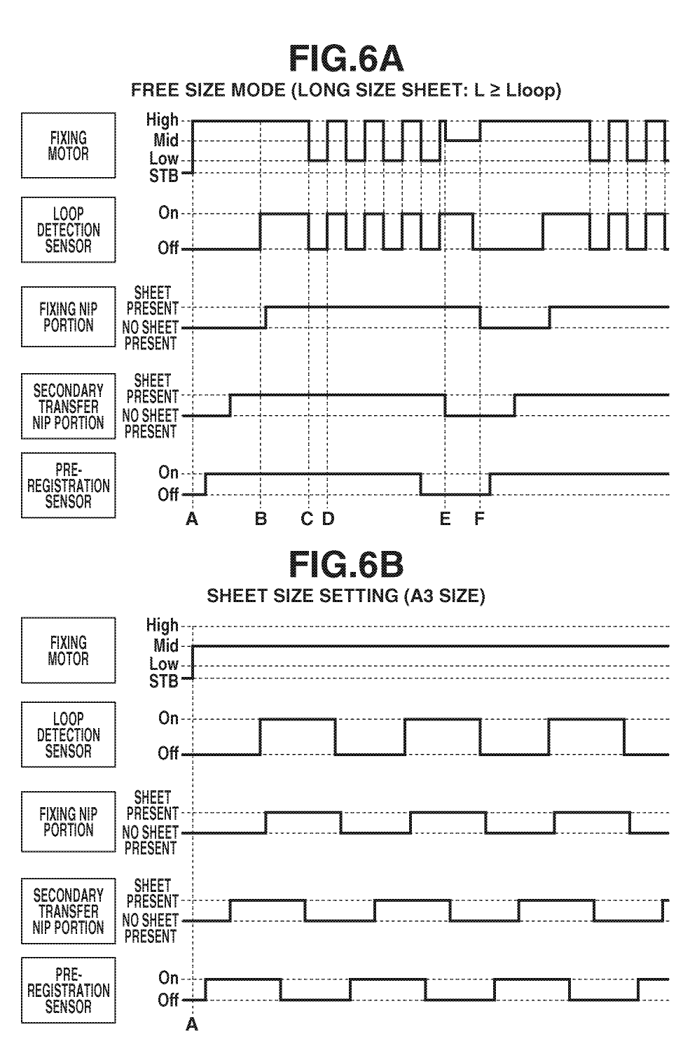

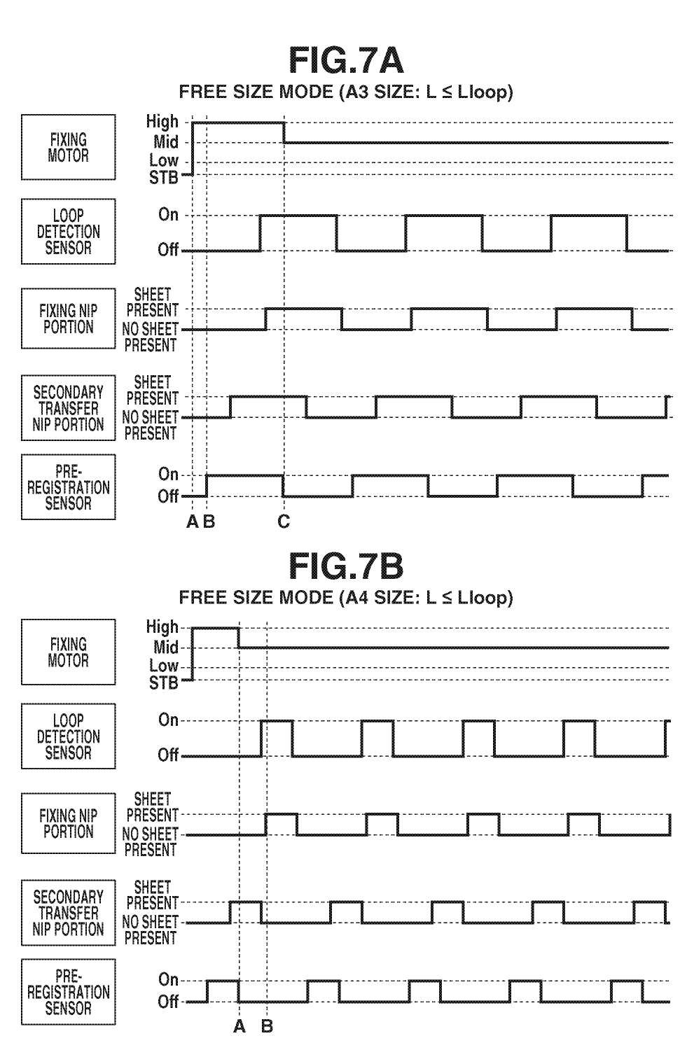

First, as an example, with reference to FIGS. 3, 4, 5, and 6A, a case where a sheet is supplied from the multi-tray 211 after a long size sheet (sheet size: 320 mm × 1200 mm) is set as a size will be described. The drawings in FIGS. 6 and 7 show the operation of different sizes of sheets of the same basis weight.

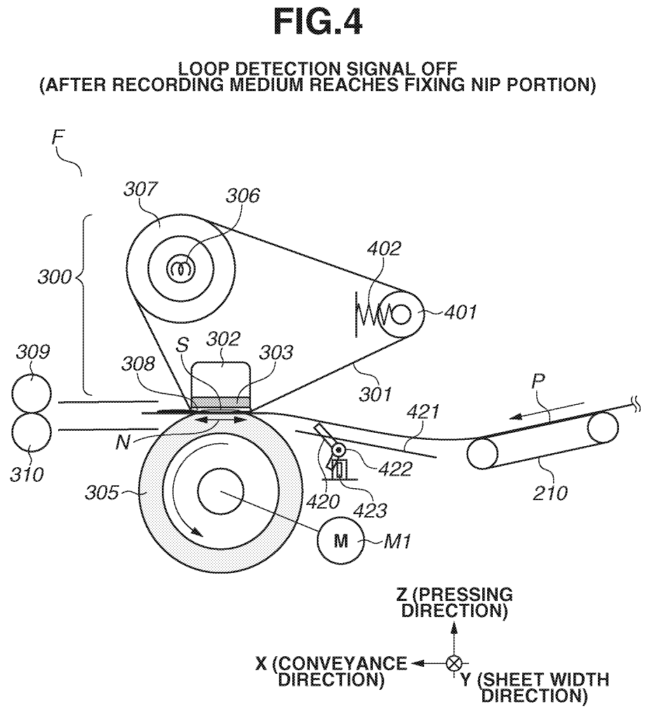

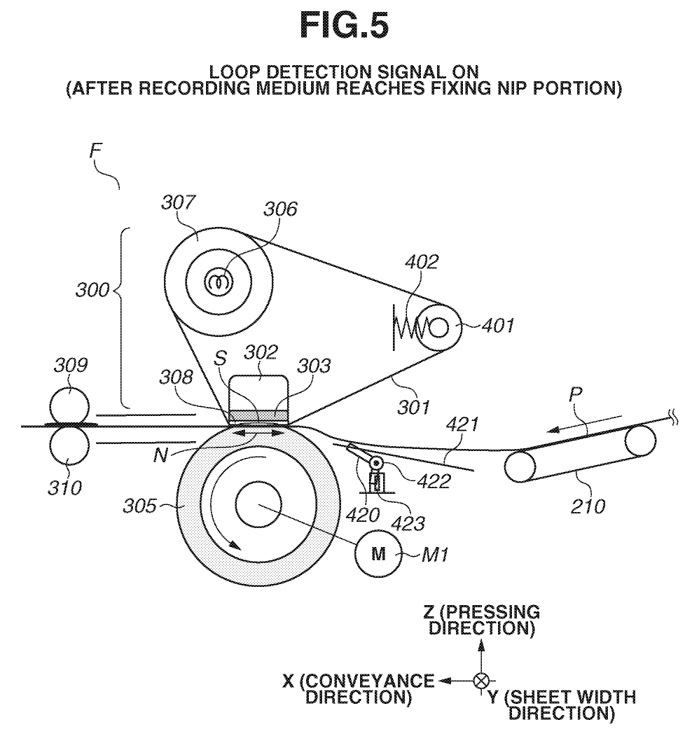

FIG. 3 is a schematic diagram illustrating the fixing device F in a case where the recording medium P has not reached the fixing nip portion N and the loop detection sensor 423 detects an ON signal. FIG. 4 is a schematic diagram illustrating the fixing device F in a case where the recording medium P has reached the fixing nip portion N, and the loop detection sensor 423 detects an OFF signal. FIG. 5 is a schematic diagram illustrating the fixing device F in a case where the recording medium P has reached the fixing nip portion N and the loop detection sensor 423 detects an ON signal. FIG. 6A is a sequence diagram in which changes of the rotational speed of the fixing motor M1, the ON/OFF of the loop detection sensor 423, the presence/absence of the sheet at the fixing nip portion N, the presence/absence of the sheet at the secondary transfer portion (secondary transfer nip portion), and the ON/OFF of the pre-registration sensor 212 are illustrated in a time-series order from when an image forming instruction is received.

In step S1, upon receiving the image forming instruction, the flowchart in FIG. 8B starts. In step S2, the control unit 30 determines whether a free size setting is made. In a case where a sheet size is set via the operation unit 4 (NO in step S2), the processing proceeds to step S12. In step S12, the control unit 30 determines whether the sheet size in the conveyance direction L ≥ Lloop is satisfied. Since the sheet size in the conveyance direction is 1200 mm and L ≥ Lloop is satisfied (YES in step S12), the processing proceeds to step S13. In step S13, immediately after starting the sheet supply, the control unit 30 changes the speed of the fixing motor M1 from the stand-by speed (STB) to the "High" speed, and starts the operation (point "A" in FIG. 6A). When the leading edge of the recording medium P conveyed from the pre-fixing conveyance belt 210 reaches the loop detection flag 420, the loop detection flag 420 is rotated by the recording medium P, and the loop detection sensor 423 detects an ON signal (see FIG. 3, and point "B" in FIG. 6A).

The recording medium P is further conveyed, and in step S14, in a case where the recording medium P has reached the fixing nip portion N (YES in step S14), the processing proceeds to step S15. In step S15, since the fixing motor M1 is operating at "High" speed, the loop of the recording medium P located across the pair of secondary transfer rollers 205 and 206, and the fixing nip portion N is eliminated. When the loop of the recording medium P is eliminated, the loop detection sensor 423 detects an OFF signal due to the change of the orientation of the loop detection flag 420, and the speed of the fixing motor M1 changes to "Low" (see FIG. 4, and point "C" in FIG. 6A). When the speed of the fixing motor M1 is "Low", the loop of the recording medium P located across the pair of secondary transfer rollers 205 and 206, and the fixing nip portion N increases. When the loop of the recording medium P increases to change the orientation of the loop detection flag 420, the loop detection sensor 423 detects an ON signal to change the speed of the fixing motor M1 to "High" (see FIG. 5 and point "D" in FIG. 6A). In this way, the speed of the fixing motor M1 is switched between "High" and "Low", in response to the signal of the loop detection sensor 423. In this way, the recording medium P can be conveyed while keeping a constant loop without pulling the recording medium P located across the pair of secondary transfer rollers 205 and 206, and the fixing nip portion N too tight and too loose.

Since the image distortion at the secondary transfer time is not generated after the trailing edge of the recording medium P passes through the pair of secondary transfer rollers 205 and 206, the speed of the fixing motor M1 is switched to "Middle" (point "E" in FIG. 6A). Then, at a timing at which the trailing edge of the recording medium P has passed through the fixing nip portion N, the speed of the fixing motor M1 is switched to "High" (point "F" in FIG. 6A) for the next recording medium P.

As described above, in the case where the sheet size L ≥ Lloop is satisfied (NO in step S2, and YES in step S12), the loop control is performed. On the other hand, in a case where the sheet size L < Lloop is satisfied (NO in step S2, and NO in step S12), the processing proceeds to step S16. In step S16, the speed of the fixing motor M1 is fixed to "Middle". As an example, a case where a sheet is supplied after an A3 size (sheet size: 297 mm × 420 mm) is set as the size is illustrated in FIG. 6B. Since the sheet size L < Lloop is satisfied, the fixing motor M1 operates at the "Middle" speed immediately after supplying the sheet (point "A" in FIG. 6B), and in step S16, the motor speed of the fixing motor M1 is maintained at "Middle" regardless of the signal of the loop detection sensor 423.

Next, a case where the sheet is supplied in the free size mode (YES in step S2) will be described. In the free size mode, since the size of the recording medium P is not set, although it is possible to detect the size in the direction orthogonal to the conveyance direction by side regulation plates for regulating edges of the recording medium P, the supply of the sheet starts in a state where the size in the conveyance direction of the recording medium P is indefinite. However, in a case where the sheet is supplied from the sheet feed cassette 8 or 9, since a technique of determining a sheet size by the rear end regulation plate before supplying the sheet is widely employed, in the present embodiment, a description will be given assuming that the sheet is supplied from the multi-tray 211.

Since the size of the recording medium P in the conveyance direction is indefinite (YES in step S2), the processing proceeds to step S3. In step S3, the supply of the sheet starts in a state where the size of the sheet in the conveyance direction is set to a maximum size (referred to as Lmax) suppliable by the image forming apparatus 1. For example, assume that Lmax is 1500 mm. In step S4, since Lmax ≥ Lloop is satisfied, the fixing motor M1 starts operating at "High" speed immediately after supplying the sheet. Then, the leading edge of the first sheet of the recording medium P reaches the pre-registration sensor 212, and the pre-registration sensor 212 detects an ON signal. The recording medium P is further conveyed, and when the trailing edge of the first sheet of the recording medium P passes through the pre-registration sensor 212, the pre-registration sensor 212 detects an OFF signal. The size of the recording medium P in the conveyance direction is determined from a time during which the pre-registration sensor 212 keeps detecting the ON signal, and the size information of the recording medium P in the conveyance direction is overwritten with the size determined from Lmax. In step S9, the control unit 30 determines the size of the first sheet of the recording medium P. In a case where the size of the first recording medium P is determined (YES in step S9), the processing proceeds to step S10. In step S10, the control unit 30 determines whether the overwritten size in the conveyance direction ≥ Lloop is satisfied. In a case where the size in the conveyance direction ≥ Lloop is satisfied (YES in step S10), a normal loop control (state illustrated in FIG. 6A) is continuously performed. In a case where the overwritten size in conveyance direction < Lloop is satisfied (NO in step S10), the processing proceeds to step S11. In step S11, the speed of the fixing motor M1 is switched to "Middle". In a case where the sheet size of the first recording medium P is not determined (NO in step S9), the processing returns to step S5.

A case where the recording medium P of A3 size (sheet size: 297 mm × 420 mm) is supplied from the multi-tray 211 in the free size mode (YES in step S2) will be described with reference to FIG. 7A.

In step S4, immediately after starting the sheet supply, the fixing motor M1 operates at "High" speed (point "A" in FIG. 7A). Because the leading edge of the recording medium P has reached the fixing nip portion N before the trailing edge of the recording medium P passes through the pre-registration sensor 212 (YES in step S5), in step S6, the control unit 30 starts the loop control. In a case where the recording medium P has passed through the pre-registration sensor 212 (from point "B" to point "C" in FIG. 7A) (YES in step S7), the control unit 30 determines that the size in the conveyance direction is 420 mm, and the size information is overwritten (point "C" in FIG. 7A). Then, the processing proceeds to step S8. In a case where the size in the conveyance direction is smaller than Lloop (NO in step S8), the processing proceeds to step S11. In step S11, the speed of the fixing motor M1 is switched to "Middle", and the operations of the second and the subsequent recording media P are continued by maintaining the size information determined for the first sheet, regardless of the switching time of the signal from the pre-registration sensor 212. In the present embodiment, in the case of A3 size, the leading edge of the recording medium P passes through the fixing nip portion N before determination of the size of the recording medium P in the conveyance direction. Thus, while the size in the conveyance direction may be determined after the speed of the fixing motor M1 changes from "High" to "Low" by the loop control, in this case, the speed of the motor M1 changes from "Low" to "Middle".

A case where the recording medium P of an A4 size (sheet size: 297 mm × 210 mm) is supplied from the multi-tray 211 in the free size mode will be described with reference to FIG. 7B. In this case, since the trailing edge of the recording medium P passes through the pre-registration sensor 212 (YES in step S9, point "A" in FIG. 7B) before the leading edge of the recording medium P reaches the fixing nip portion N (NO in step S5, point "B" in FIG. 7B), the processing proceeds to step S10. In step S10, the control unit 30 determines that the sheet size is smaller than Lloop (NO in step S10), and the processing proceeds to step S11. In step S11, the speed of the fixing motor M1 is switched from "High" to "Middle" before the leading edge of the recording medium P reaches the fixing nip portion N.

In a case where the recording medium P with the size in the conveyance direction ≥ Lloop such as a long size sheet (sheet size: 320 mm × 1200 mm) is supplied from the multi-tray 211 in the free size mode, in the case where the size of the first recording medium P is determined (YES in step S7), the processing proceeds to step S8. In step S8, since the control unit 30 determines that the sheet size in the conveyance direction ≥ Lloop is satisfied (YES in step S8), the size information is overwritten as the sheet size in the conveyance direction ≥ Lloop. In this way, the operation of the fixing motor M1 does not change from the case where the sheet size is set via the operation unit 4, and the control unit 30 performs the loop control similar to the operation illustrated in FIG. 6A.

As described above, in the free size mode, in the case of the size that may use the loop control, the image distortion at the secondary transfer time is prevented by surely performing the loop control. In the case where the size of the recording medium P is a size that may not use the loop control, it is possible to make the impact on the service life of the fixing device F minimum by performing the loop control only until the size of the recording medium P in the conveyance direction is determined.

### Second Embodiment

In the first embodiment, in the free size mode, in the case where the size of the recording medium P is the size that does may not use the loop control, the speed of the fixing motor M1 is switched to "Middle" at the timing at which the size of the recording medium P in the conveyance direction is determined (point "C" in FIG. 7A), and the loop control starts when the leading edge of the recording medium P reaches the fixing nip portion N before the size of the recording medium P in the conveyance direction is determined, like the case where the recording medium P of the A3 size (sheet size: 297 mm × 420 mm) is supplied in the free size mode from the multi-tray 211 according to the first embodiment. However, when the size information is overwritten at the timing at which the loop control is to be switched from "High" to "Low" and switched to "Middle", since the speed at the fixing nip portion N may become higher due to the difference in the conveyance speed between the fixing nip portion N and the pair of secondary transfer rollers 205 and 206, there is a possibility that the recording medium P located across the pair of secondary transfer rollers 205 and 206, and the fixing nip portion N becomes pulled more compared to the state generated at the time of the normal loop control, which may lead to the image distortion at the secondary transfer time. As a countermeasure therefor, by switching the speed of the fixing motor M1 to "Middle" at a timing at which the recording medium has passed through the pair of secondary transfer rollers 205 and 206, it is possible to switch the speed of the fixing motor M1 in a state where the state of the recording medium P located across the pair of secondary transfer rollers 205 and 206 and the fixing nip portion N is not affected.

Further, since the present embodiment has also an advantage that it is not necessary to increase the number of switching points from the normal loop control operation method (point "E" in FIG. 6A) to the "Middle", it is possible to reduce the risk of the image defect caused at a time of changing the speed at the fixing nip portion N, and to simplify the operation method, despite slight increase in the operation time of the unnecessary loop control.

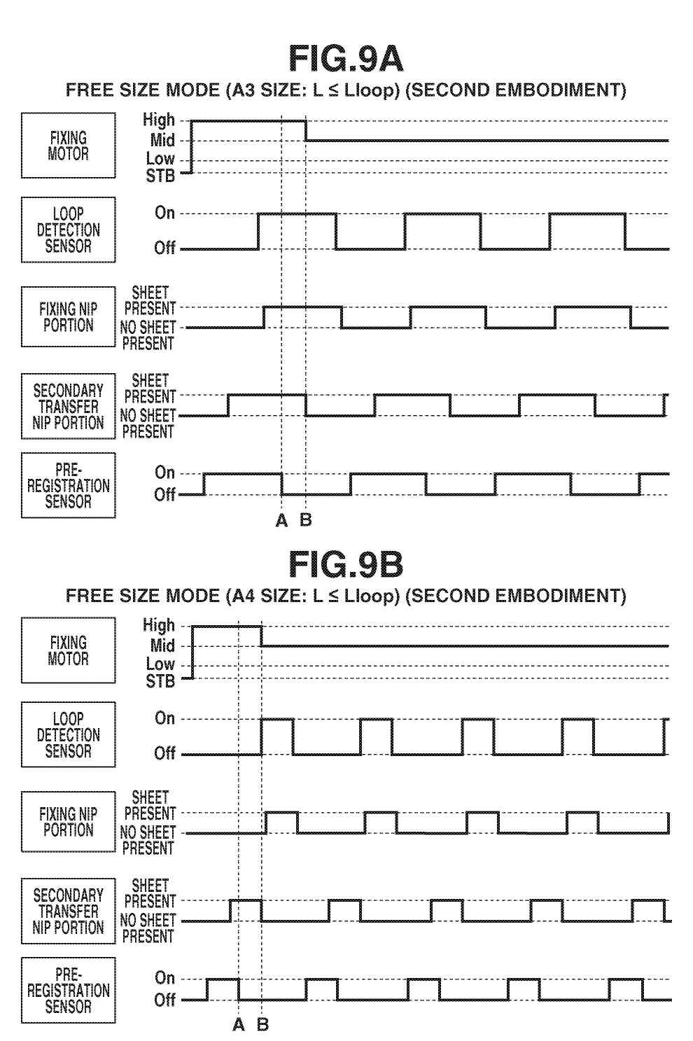

As an example, FIG. 9A illustrates a case where an A3 sheet is supplied in the free size mode, and FIG. 9B illustrates a case where an A4 sheet is supplied in the free size mode. The size of the recording medium P in the conveyance direction is determined to be < Lloop at point "A" in FIG. 9A, and point "A" in FIG. 9B based on the switching time of the signal from the pre-registration sensor 212, but the speed of the fixing motor M1 is switched to the "Middle" speed at the timing at which the recording medium P has passed through the pair of secondary transfer rollers 205 and 206 (point "B" in FIG. 9A, and point "B" in FIG. 9B).

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of priority from Japanese Patent Application No. 2025-076475, filed May 1, 2025, which is hereby incorporated by reference herein in its entirety.

What is claimed is:

1. A fixing device for fixing an unfixed toner image formed on a recording medium onto the recording medium, the fixing device comprising:
a heating rotational member configured to heat the recording medium;
a pressing rotational member configured to form, together with the heating rotational member, a fixing nip portion for nipping and conveying the recording medium;
a fixing motor configured to provide a rotational driving force to the pressing rotational member; and
a control unit configured to control a fixing speed by controlling the fixing motor,
wherein the control unit controls the fixing motor, in a case where a sheet size setting of the recording medium with a size in a conveyance direction larger than a predetermined size is made, to operate at the fixing speed of a first speed when a first sheet of the recording medium reaches the fixing device,
wherein the control unit controls the fixing motor, in a case where the sheet size setting of the recording medium with a size in the conveyance direction smaller than the predetermined size is made, to operate at the fixing speed of a second speed lower than the first speed when the first sheet of the recording medium reaches the fixing device, and
wherein the control unit controls the fixing motor, in a case of a free size mode in which the sheet size setting is not made, to operate at the fixing speed of the first speed when the first sheet of the recording medium reaches the fixing device.

2. The fixing device according to claim 1, further comprising a loop detection unit configured to detect a loop of the recording medium, on an upstream side of the fixing nip portion,
wherein the control unit performs a loop control for changing the fixing speed based on a signal from the loop detection unit in a case where the recording medium larger than the predetermined size is conveyed.

3. The fixing device according to claim 2, wherein the control unit controls the fixing motor to operate at the second speed, not based on the signal from the loop detection unit in a case where the recording medium smaller than the predetermined size is conveyed.

4. The fixing device according to claim 2, further comprising a sensor configured to determine a length of the recording medium being conveyed,
wherein, in the free size mode in which the sheet size setting is not made, the control unit performs the loop control in a case where a determination result of the sensor indicates that the recording medium is larger than the predetermined size, and
wherein the control unit does not perform the loop control in a case where the determination result of the sensor indicates that the recording medium is smaller than the predetermined size.

5. The fixing device according to claim 2,
wherein the control unit controls the fixing motor to operate at the first speed as the loop control, in a case where the loop detection unit detects that the loop is present, and
wherein the control unit controls the fixing motor to operate at a third speed lower than the second speed, in a case where the loop detection unit detects that the loop is not present.

6. The fixing device according to claim 2, further comprising a secondary transfer roller configured to transfer an image onto the recording medium, on an upstream side of the fixing device in the conveyance direction, and
wherein the loop is a slack of the recording medium generated between the secondary transfer roller and the fixing nip portion.

7. An image forming apparatus including an image forming unit configured to form a toner image on a recording medium, and a fixing unit configured to fix an unfixed toner image formed by the image forming unit onto the recording medium, the fixing unit comprising:
a heating rotational member configured to heat the recording medium;
a pressing rotational member configured to form, together with the heating rotational member, a fixing nip portion for nipping and conveying the recording medium;
a fixing motor configured to provide a rotational driving force to the pressing rotational member; and
a control unit configured to control a fixing speed by controlling the fixing motor,
wherein the control unit controls the fixing motor, in a case where a sheet size setting of the recording medium with a size in a conveyance direction larger than a predetermined size is made, to operate at the fixing speed of a first speed when a first sheet of the recording medium reaches the fixing unit,
wherein the control unit controls the fixing motor, in a case where the sheet size setting of the recording medium with a size in the conveyance direction smaller than the predetermined size is made, to operate at the fixing speed of a second speed lower than the first speed when the first sheet of the recording medium reaches the fixing unit, and
wherein the control unit controls the fixing motor, in a case of a free size mode in which the sheet size setting of the recording medium in the conveyance direction is not made, to operate at the fixing speed of the first speed when the first sheet of the recording medium reaches the fixing unit.

8. The image forming apparatus according to claim 7, wherein the second speed is a same speed as a speed when the conveyed recording medium passes through the image forming unit.

9. The image forming apparatus according to claim 7, further comprising a loop detection unit configured to detect a loop of the recording medium, on an upstream side of the fixing nip portion,
wherein the control unit performs a loop control for changing the fixing speed based on a signal from the loop detection unit in a case where the recording medium larger than the predetermined size is conveyed.

10. The image forming apparatus according to claim 9, wherein the control unit controls the fixing motor to operate at the second speed, not based on the signal from the loop detection unit in a case where the recording medium smaller than the predetermined size is conveyed.

11. The image forming apparatus according to claim 9, further comprising a sensor configured to determine a length of the recording medium being conveyed,
wherein, in the case of the free size mode in which the sheet size setting is not made, the control unit performs the loop control in a case where a determination result of the sensor indicates that the recording medium is larger than the predetermined size, and
wherein the control unit does not perform the loop control in a case where the determination result of the sensor indicates that the recording medium is smaller than the predetermined size.

12. The image forming apparatus according to claim 9,
wherein the control unit controls the fixing motor to operate at the first speed as the loop control, in a case where the loop detection unit detects that the loop is present, and
wherein the control unit controls the fixing motor to operate at a third speed lower than the second speed, in a case where the loop detection unit detects that the loop is not present.

13. The image forming apparatus according to claim 9, further comprising a secondary transfer roller configured to transfer an image onto the recording medium, on an upstream side of the fixing unit in the conveyance direction,
wherein the loop is a slack of the recording medium generated between the secondary transfer roller and the fixing nip portion.

14. The image forming apparatus according to claim 7, wherein, in a case of the free size mode, the recording medium is a recording medium fed from a multi-tray.

15. The image forming apparatus according to claim 1, wherein the recording medium with a size in the conveyance direction larger than the predetermined size and the recording medium with a size in the conveyance direction smaller than the predetermined size is a same basis weight.
